(19) United States
(12) Patent Application Publication
(10) Pub. No.: US 2020/0086729 A1
(43) Pub. Date: Mar. 19, 2020

(54) WEATHER STRIP TENSIONER

(71) Applicant: AISIN TECHNICAL CENTER OF AMERICA, INC., Northville, MI (US)

(72) Inventor: Micah WEDEKIND, Livonia, MI (US)

(73) Assignee: AISIN TECHNICAL CENTER OF AMERICA, INC., Northville, MI (US)

(21) Appl. No.: 16/132,774

(22) Filed: Sep. 17, 2018

(51) Int. Cl. B60J 10/82; B60J 10/33; B60J 10/40

(52) U.S. Cl. CPC B60J 10/82; B60J 7/0435; B60J 10/40; B60J 10/33

(57) ABSTRACT

A sunroof apparatus for an automotive vehicle includes a fixed glass panel having an outer rim, a movable glass panel having an outer rim, a weather strip between the glass panel and the movable glass panel, and a molded endcap attached to ends of the portion of the outer rim. A portion of the outer rim of the movable glass panel in the width direction of the vehicle is adjacent to the fixed panel and constitutes a water channel. A lock strip having a T-shaped cross-section extends along an inside of and beyond the ends of the water channel. The molded endcap places a force against a protruding portion of the lock strip that extends beyond the ends of the water channel to hold ends of the weather strip. The ends of the weather strip are prevented from being peeled back and creating a gap.

### BACKGROUND

### Field of the Disclosure

The present disclosure is directed towards a weather strip tensioner for a vehicle sunroof.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Automotive vehicles may be provided with a sunroof or moonroof in the roof of the passenger compartment. A sunroof or moonroof assembly may include a glass panel in a window assembly. In the case of a sunroof assembly, an opening mechanism may also be included. The glass panel may include a movable glass panel and a fixed glass panel, or may include just a movable glass panel. The movable glass panel opens and closes a substantially rectangular opening defined by a periphery of the housing. The housing is mounted to an opening in the vehicle roof. A weather strip is provided to seal a boundary between the movable glass panel and the fixed glass panel.

The weather strip may take the form of a front rim portion of the fixed panel. The rim may constitute a rain channel. The shape of the front rim may be that of a trough-like shape with ends that extend to edges of the housing that surrounds the movable glass panel and fixed glass panel. The weather strip may include a vertical portion that may come into contact with a rim of the movable glass panel.

There are various approaches to assembling the weather strip in the sunroof. One approach has been to use a double sided tape that fixes the weather strip to a front rim portion of the fixed glass panel or the rim of the movable glass panel. Another approach has been to form engagement convex portions that engage with a plurality of engaging recesses of the fixed glass panel. However, in each case ends of the weather strip tend to peel back and create a gap. This is because the double sided tape weakens in its hold of the weather strip near the ends over time. The convex engagement portion holds most of the weather strip in place, but not ends of the weather strip. Movement of the movable glass panel tends to cause slippage of the weather strip, and over time, ends of the weather strip tend to peel back.

These and other problems are addressed by the disclosure.

### SUMMARY

The present disclosure relates to a sunroof apparatus for an automotive vehicle, including at least one fixed glass panel having an outer rim, at least one movable glass panel having an outer rim, a portion of the outer rim of the movable glass panel in the width direction of the vehicle is adjacent to the fixed panel and constitutes a water channel, a lock strip having a T-shaped cross-section extends along an inside of and beyond the ends of the water channel, a weather strip between one of the at least one glass panel and one of the at least one movable glass panel, a molded endcap attached to ends of the portion of the outer rim. The molded endcap places a force against a protruding portion of the lock strip that extends beyond the ends of the water channel to hold ends of the weather strip.

Accordingly, it is one object of the present disclosure to provide a structure that holds ends of a weather strip for a sunroof from peeling back.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic plan view of a sunroof apparatus for a vehicle according to an exemplary aspect of the disclosure;

FIG. 2 is a diagram to illustrate movement of the movable panel according to an exemplary aspect of the disclosure;

FIG. 3 is a partial view of a sunroof apparatus in the vicinity of an end of a weather strip held in place by a double sided tape;

FIG. 4 is a partial view of a sunroof apparatus in the vicinity of an end of a weather strip held in place by a protrusion tensioner according to an exemplary aspect of the disclosure;

FIG. 5 is a partial view of a sunroof apparatus showing the protrusion tensioner according to an exemplary aspect of the disclosure;

FIG. 6 is a partial view of a sunroof apparatus showing a protrusion tensioner and an associated endcap according to an exemplary aspect of the disclosure;

FIG. 7 is a partial view of a sunroof apparatus showing an exterior view of the endcap according to an exemplary aspect of the disclosure;

FIG. 8 is a partial view of a sunroof apparatus showing an end view of the weather strip according to an exemplary aspect of the disclosure;

FIG. 9 is a partial view of a sunroof apparatus at a mid-section of the weather strip according to an exemplary aspect of the disclosure;

FIG. 10 is a partial view of a sunroof apparatus without the weather strip according to an exemplary aspect of the disclosure; and

FIG. 11 is a top view of FIG. 10.

### DETAILED DESCRIPTION

The description set forth below in connection with the appended drawings is intended as a description of various aspects of the disclosed subject matter and is not necessarily intended to represent the only aspects). In certain instances, the description includes specific details for the purpose of providing an understanding of the disclosed subject matter. However, it will be apparent to those skilled in the art that aspects may be practiced without these specific details. In some instances, well-known structures and components may be shown in block diagram form in order to avoid obscuring the concepts of the disclosed subject matter.

Reference throughout the specification to “one aspect” or “an aspect” means that a particular feature, structure, characteristic, operation, or function described in connection with an aspect is included in at least one aspect of the disclosed subject matter. Thus, any appearance of the phrases “in one aspect” or “in an aspect” in the specification is not necessarily referring to the same aspect. Further, the particular features, structures, characteristics, operations, or functions may be combined in any suitable manner in one or more aspects. Further, it is intended that aspects of the disclosed subject matter can and do cover modifications and variations of the described aspects.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “upper,” “lower,” “front,” “rear,” “side,” “interior,” “exterior,” and the like that may be used herein, merely describe points of reference and do not necessarily limit aspects of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit aspects of the disclosed subject matter to any particular configuration or orientation.

Referring now to the drawings, wherein like reference numerals designate identical or corresponding parts throughout several views, the following description relates to a sunroof assembly for an automotive vehicle. Automotive vehicles may be provided with sunroof assemblies having a fixed panel and a movable panel with a weather strip in between. Ends of the weather strip may peel back and create a gap. Disclosed are embodiments that provide a solution to this problem.

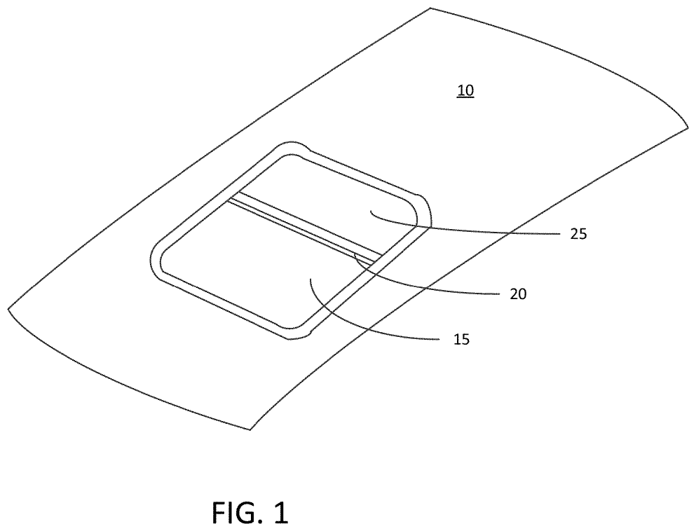

A sunroof apparatus of a vehicle roof 10 will be explained. Hereinafter, a front/rear direction refers to a forward/rearward direction relative to a traveling direction of the vehicle having the roof 10. A right/left direction or a width direction refers to a direction of the vehicle relative to the front of the vehicle. FIG. 1 is a schematic plan view of a sunroof apparatus for a vehicle according to an exemplary aspect of the disclosure. The sunroof apparatus includes a movable glass panel 15, a fixed glass panel 25 and a weather strip 20 between the two panels. The movable glass panel 15 can move to a closed position over an opening portion of the same size. Although the drawing shows a single fixed panel and a single movable panel, the sunroof apparatus may have more than one fixed panel and/or more than one movable panel. A movable panel may be in a forward position toward the front of the vehicle. However, the movable panel may be in a rearward position, or in a middle position of the sunroof apparatus. The movable panel is arranged to be lifted at an end that is adjacent to a fixed panel and slid over the fixed panel. The weather strip may be made of a rubber material.

The movable glass panel 15 and a fixed glass panel 25 are encased by a housing that surrounds the outer rim of each panel when the movable glass panel 15 is in a closed position. To open the sunroof, the movable glass panel 15 is tilted upward and is slid along a pair of rails to a position above the fixed glass panel 25. Rims of the movable glass panel 15 and the fixed glass panel 25 may be of a light metal, such as aluminum or stainless steel. The housing also may be of a light metal.

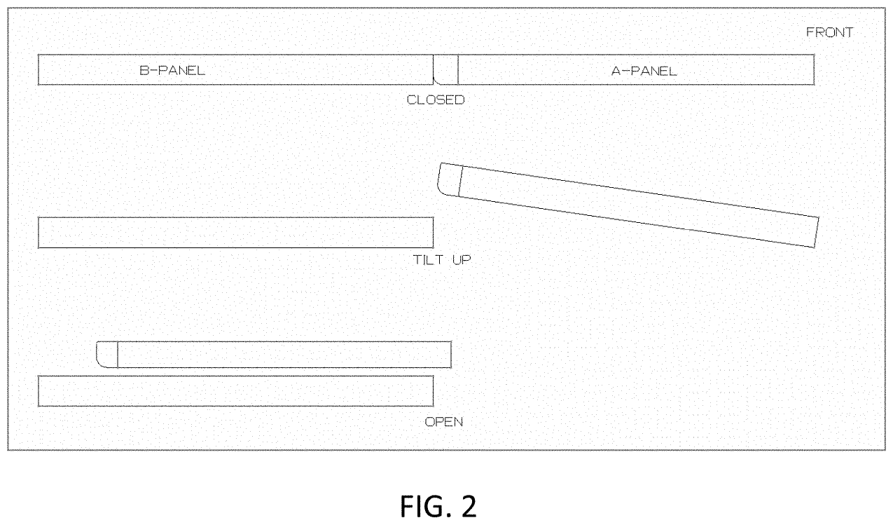

FIG. 2 is a diagram to illustrate movement of the movable panel according to an exemplary aspect of the disclosure. The movable glass panel is opened by tilting up the end that is adjacent to the fixed glass panel. When the movable glass panel moves from a closed position to an open position, friction between the weather strip and the rim of the fixed panel may cause right and/or left ends of the weather strip, in the width direction, to peel back. Similarly, when the movable glass panel moves from an open position to a closed position, friction may cause the right and/or left ends of the weather strip to peel back. Subsequently, when the movable glass panel is moved to a closed position, there may be a gap at the ends of the weather strip such that the weather strip no longer completely seals the space between the movable panel and the fixed panel.

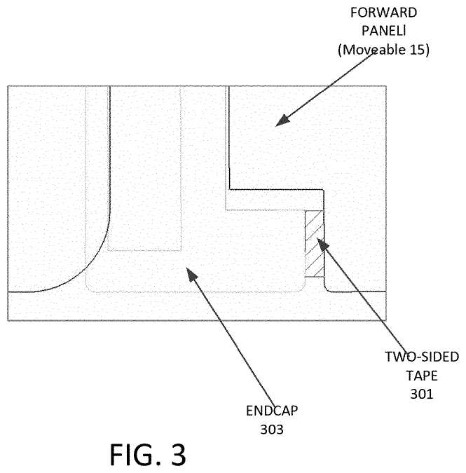

FIG. 3 is a partial view of a sunroof apparatus in the vicinity of an end of a weather strip held in place by a double sided tape. As mentioned above, one approach to preventing the ends of the weather strip from peeling back may be to use a two-sided tape 301, also referred to as double sided tape, to ensure proper attachment of the weather strip via the endcap 303 to the movable panel 15. However, the double sided tape may wear out over time and loose its adhesive ability especially at either end of the weather strip. Also, the two-sided tape is an additional material that needs to be provided.

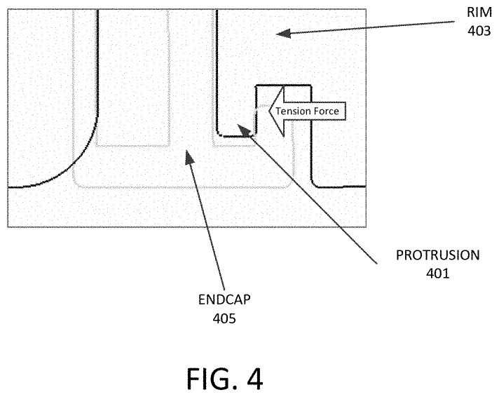

FIG. 4 is a partial view of a sunroof apparatus in the vicinity of an end of a weather strip held in place by a protrusion tensioner according to an exemplary aspect of the disclosure. Rather than applying an adhesive tape or glue to secure a weather strip, an aspect of the present disclosure is to include a protruding tensioner 401 that secures the ends of the weather strip and prevents the ends from peeling away from the rim 403 of the movable panel. An endcap 405 holds tension on the protruding tensioner 401 in the direction of Tension Force to hold ends of the weather strip in place.

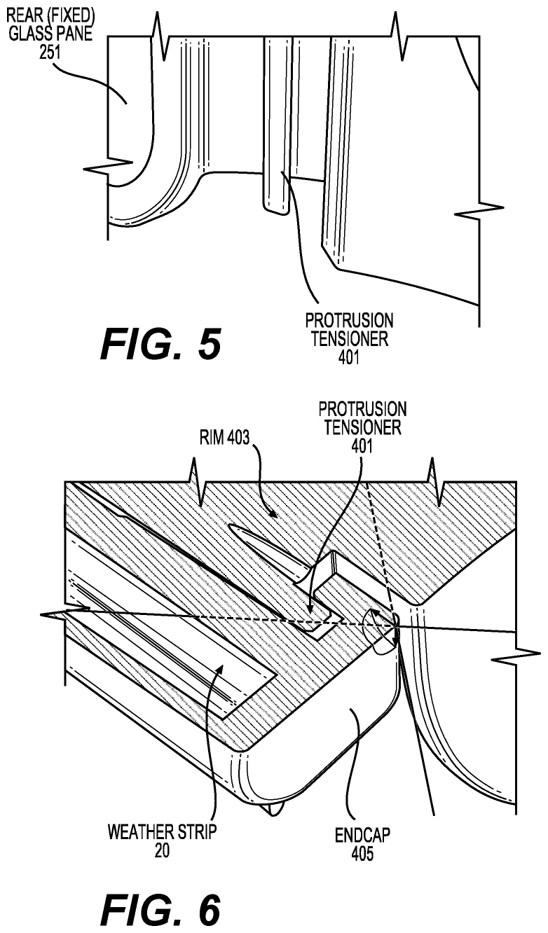

FIG. 5 is a partial view of a sunroof apparatus showing the protrusion tensioner according to an exemplary aspect of the disclosure. Protrusion tensioner 401 protrudes outwards beyond ends of a water channel in a right or left direction (width direction) of the vehicle. The protrusion tensioner 401 may be provided as part of the rim of a panel. In one embodiment, the protrusion tensioner 401 is part of the rim of the movable panel 15. The protrusion 401 adds support by way of the extension of an attachment clip of the rim and adds tension with the aid of a molded endcap 405. The molded endcap 405 may be of a molded plastic having enough flexibility to administer a force against the protrusion tensioner 401.

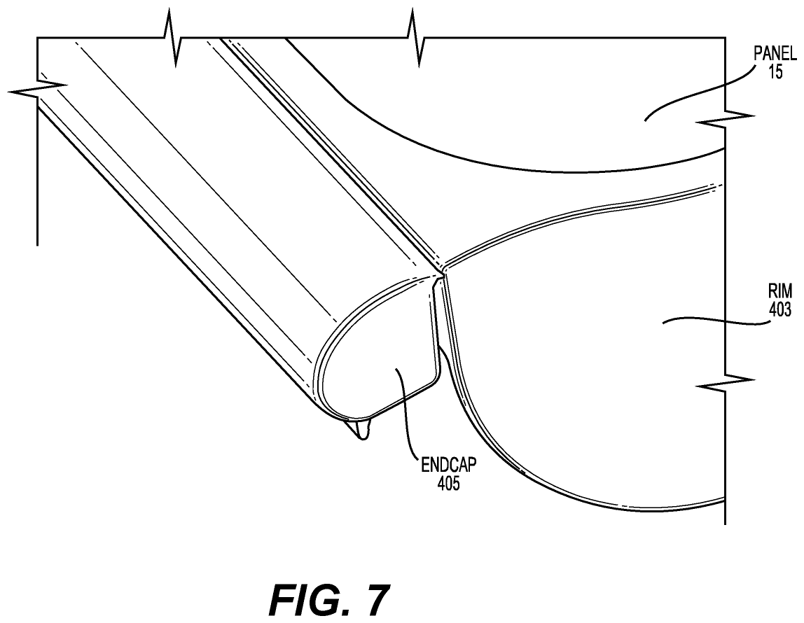

FIG. 6 is a partial view of a sunroof apparatus showing a protrusion tensioner and an associated endcap according to an exemplary aspect of the disclosure. As shown in FIG. 6, the molded endcap 405 places tension on the protrusion tensioner 401. The molded endcap wraps underneath an extended attachment portion of an attachment clip to hold the endcap 405 against the rim 403.

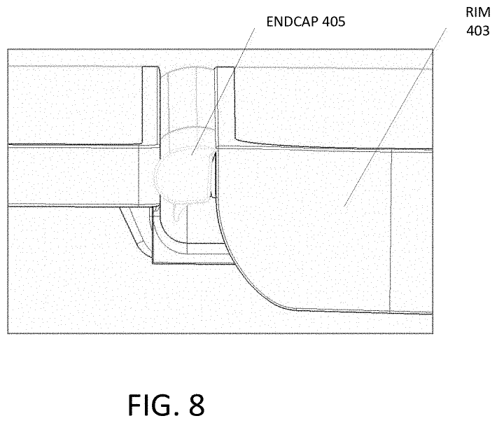

FIG. 7 is a partial view of a sunroof apparatus showing an exterior view of the endcap according to an exemplary aspect of the disclosure. As can be seen in the figure, endcap 405 covers the end of the weather strip. FIG. 8 is a partial view of a sunroof apparatus which shows an end view of FIG. 7 according to an exemplary aspect of the disclosure.

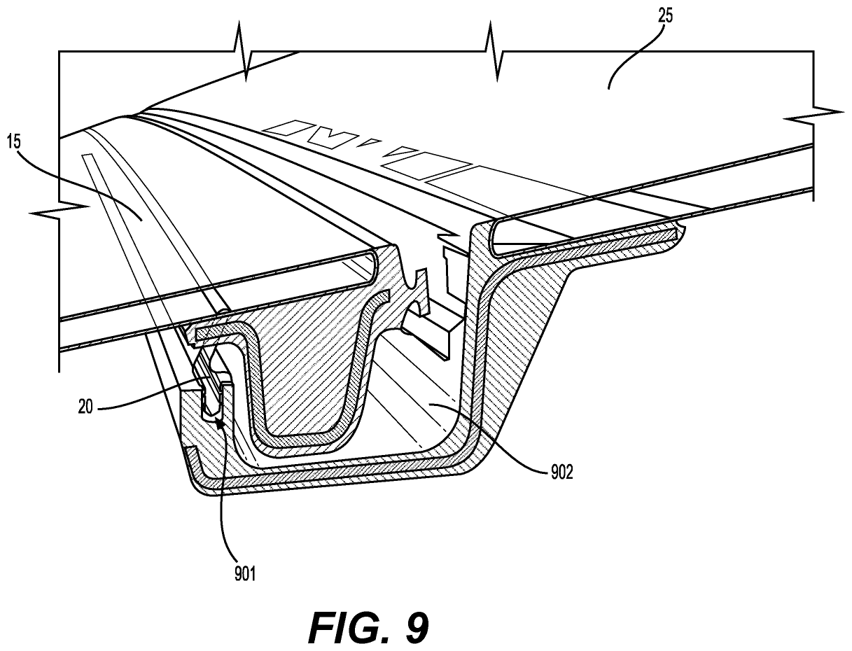

FIG. 9 is a partial view of a sunroof apparatus at a mid-section of the weather strip according to an exemplary aspect of the disclosure. During assembly, the rim of the fixed panel 25 may be held with the rim of the movable panel 15. The rim 403 of the movable panel 15 may constitute a rain channel 902. The rain channel 902 may form a U-shape to allow water to be caught. The U-shape includes one vertical side at the rim of the movable panel 15 and another vertical side away from the rim. As shown in FIG. 9, the vertical recess 901 is provided away from the tip of the rim of the rain channel 902. The weather strip 20 may be attached to the vertical recess 901.

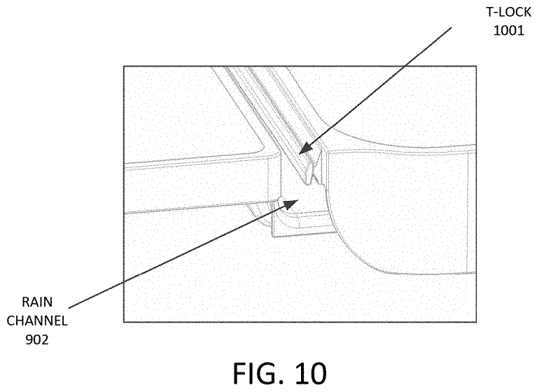

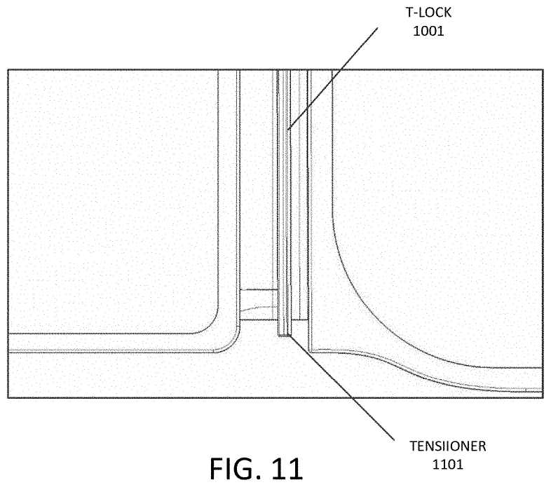

FIG. 10 is a partial view of a sunroof apparatus without the weather strip to expose a T-lock according to an exemplary aspect of the disclosure. In one embodiment, a T-lock 1001 is formed along an inner surface of a rain channel 902 of the moving panel 15. The weather strip 20 is mounted to the end of the T-lock 1001. FIG. 11 is a top view of FIG. 10. In the one embodiment, the T-lock 1001 extends as a protrusion 1101 in the vehicle width direction. The protrusion 1101 adds tension when the molded endcap is attached to the rim of the moving panel 156.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components.

The foregoing discussion describes merely exemplary embodiments of the present disclosure. As will be understood by those skilled in the art, the present disclosure may be embodied in other specific forms without departing from the spirit or essential characteristics thereof. Accordingly, the disclosure is intended to be illustrative, but not limiting of the scope of the disclosure, as well as the claims. The disclosure, including any readily discernible variants of the teachings herein, defines in part, the scope of the foregoing claim terminology such that no inventive subject matter is dedicated to the public.

1. A sunroof apparatus for an automotive vehicle, comprising:
at least one fixed glass panel having an outer rim;
at least one movable glass panel having an outer rim;
a portion of the outer rim of the movable glass panel in the width direction of the vehicle is adjacent to the fixed panel and constitutes a water channel, a lock strip having a T-shaped cross-section extends along an inside of and beyond the ends of the water channel;
a weather strip between one of the at least one fixed glass panel and one of the at least one movable glass panel; and
a molded endcap attached to ends of the portion of the outer rim,
wherein the molded endcap places a force against a protruding portion of the lock strip that extends beyond the ends of the water channel to hold ends of the weather strip.

2. The sunroof apparatus of claim 1, wherein the endcap wraps underneath an attachment clip of the portion of the outer rim to hold the endcap against the rim securely.

3. The sunroof apparatus of claim 1, further comprising a vertical recess in the end tip of the portion of the rim, wherein the weather strip is attached to the vertical recess.
